(19) United States
(12) Patent Application Publication
(10) Pub. No.: US 2024/0223041 A1
(43) Pub. Date: Jul. 4, 2024

(54) MOTOR AND PUMP

(71) Applicant: NIDEC POWERTRAIN SYSTEMS CORPORATION, Kanagawa (JP)

(72) Inventor: Shigehiro KATAOKA, Kanagawa (JP)

(73) Assignee: NIDEC POWERTRAIN SYSTEMS CORPORATION, Kanagawa (JP)

(21) Appl. No.: 18/393,484

(22) Filed: Dec. 21, 2023

(30) Foreign Application Priority Data
Dec. 28, 2022 (JP) 2022-212474

(51) Int. Cl. H02K 3/52; H02K 3/28; H02K 5/22

(52) U.S. Cl. CPC H02K 3/522; H02K 3/28; H02K 5/225

(57) ABSTRACT

Provided are: a motor part including a rotor rotatable around a central axis; a stator facing rotor in radial direction; a circuit board arranged on axial one side of motor part; a connection terminal arranged between stator and circuit board; a first housing having a first opening and accommodating motor part; and a second housing arranged on axial one side of first housing. Stator includes: an annular stator core fixed to first housing, a coil including multiple coil bodies attached to stator core, and an insulator. Connection terminal electrically connects coil and circuit board. Second housing includes a cylindrical board accommodator extending axially, and accommodating a circuit board; a board holding part holding circuit board; and a terminal holding part holding connection terminal. Outer peripheral surface of accommodator constitutes a portion of outer peripheral surface of second housing. Terminal holding part is connected to an inner side surface of accommodator.

### CROSS-REFERENCE TO RELATED APPLICATIONS

The disclosure claims priority under 35 U.S.C. § 119 to Japanese Application No. 2022-212474 filed on Dec. 28, 2022 the entire content of which is incorporated herein by reference.

### BACKGROUND

### Field of the Invention

The disclosure relates to a motor and a pump.

### Background

A motor is known in which a stator winding included in a stator and a circuit board that supplies power to the stator winding are electrically connected via a guide plate. For example, there is provided a motor having a structure for electrically connecting a stator winding and a circuit board by a guide plate held by a stator fixed to a motor housing.

In such a motor as described above, if the stator is fixed to the motor housing with its circumferential position displaced with respect to the motor housing, the circumferential position of the guide plate with respect to the circuit board is displaced. In this case, since the circumferential position of the guide plate cannot be aligned with the circuit board, there is a possibility that the connection between the guide plate and the circuit board becomes difficult. Thus, when the stator is mounted on the motor housing, it is necessary to increase the positional accuracy of the stator in the circumferential direction with respect to the motor housing, and this increases the number of manufacturing man-hours of the motor.

One of the purposes of this disclosure is to provide a motor and a pump that are able to suppress an increase in manufacturing man-hours in light of the above circumstances.

### SUMMARY

One embodiment of the motor of the disclosure includes: a motor part including a rotor rotatable around a central axis, and a stator facing the rotor in a radial direction with a gap therebetween; a circuit board arranged on an axial one side of the motor part; a connection terminal arranged between the stator and the circuit board in an axial direction; a first housing having a first opening that is open at the axial one side and accommodating the motor part; and a second housing arranged on the axial one side of the first housing. The stator includes: an annular stator core fixed to the first housing, a coil including multiple coil bodies attached to the stator core, and an insulator arranged between the stator core and the coil. The connection terminal electrically connects the coil and the circuit board. The second housing includes: a board accommodator having a cylindrical shape that extends in the axial direction and accommodating the circuit board, a board holding part holding the circuit board, and a terminal holding part holding the connection terminal. An outer peripheral surface of the board accommodator constitutes a portion of an outer peripheral surface of the second housing. The terminal holding part is connected to an inner side surface of the board accommodator.

One embodiment of the pump of the disclosure includes the above motor, and a pump mechanism connected to the rotor.

### BRIEF DESCRIPTION OF THE DRAWINGS

FIG. 1 is a perspective view showing a pump according to a first embodiment.

FIG. 2 is a sectional view showing the pump according to the first embodiment.

FIG. 3 is a top view showing a part of the pump according to the first embodiment.

FIG. 4 is a sectional view showing a part of the pump according to the first embodiment.

FIG. 5 is a perspective view showing a part of the pump according to the first embodiment.

FIG. 6 is a perspective view showing a terminal holding part of the first embodiment.

FIG. 7 is a perspective view showing the terminal holding part and a connection terminal according to the first embodiment.

FIG. 8 is a perspective view showing a terminal holding part and a connection terminal according to a second embodiment.

FIG. 9 is a sectional view showing the terminal holding part and the connection terminal according to the second embodiment.

### DETAILED DESCRIPTION

According to one aspect of the disclosure, in the motor and the pump, by simplifying the work of connecting the coil wire and the circuit board via the connection terminal, it is possible to suppress the increase of assembly man-hours.

The above and other elements, features, steps, characteristics and advantages of the present disclosure will become more apparent from the following detailed description of the preferred embodiments with reference to the attached drawings.

In the following description, a Z-axis is shown as appropriate in the drawing. The Z-axis indicates the direction in which a central axis J of the embodiments to be described below extends. The central axis J shown in each drawing is a virtual axis. In the following description, the direction in which the central axis J extends, namely the direction parallel to the Z-axis, is referred to as “axial direction”. The radial direction centered on the central axis J is simply referred to as “radial direction”. The circumferential direction centered on the central axis J is simply referred to as “circumferential direction”. The side in the axial direction toward which the arrow of the Z-axis indicates (+Z side) is referred to as the “upper side” or “axial one side”. The side in the axial direction opposite to the side that the arrow of the Z-axis indicates (−Z side) is referred to as the “lower side” or the “axial other side”. Moreover, the upper side and the lower side are merely names for explaining relative positional relationship between respective parts, and the actual layout relationship or the like may be those other than the layout relationship or the like indicated by these names.

The circumferential direction is indicated by an arrow θ in each drawing. The side facing the arrow θ in the circumferential direction is referred to as “circumferential one side”. The side in the circumferential direction opposite to the direction that the arrow θ indicates is referred to as “circumferential other side”. The circumferential one side is a side that advances clockwise around the central axis J when viewed from the axial one side. The circumferential other side is a side that advances counterclockwise around the central axis J when viewed from axial one side.

### First Embodiment

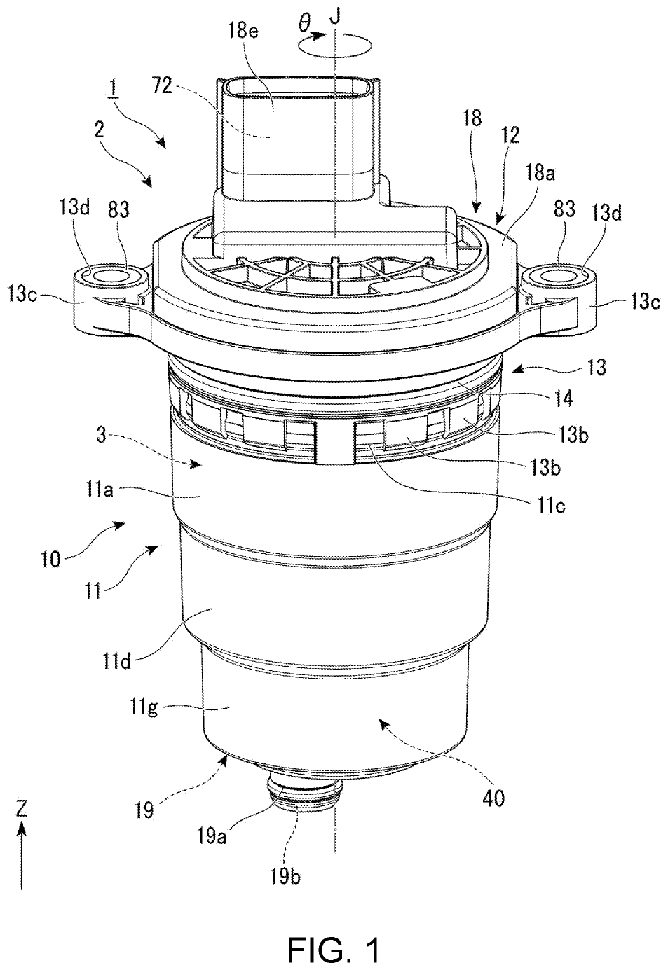

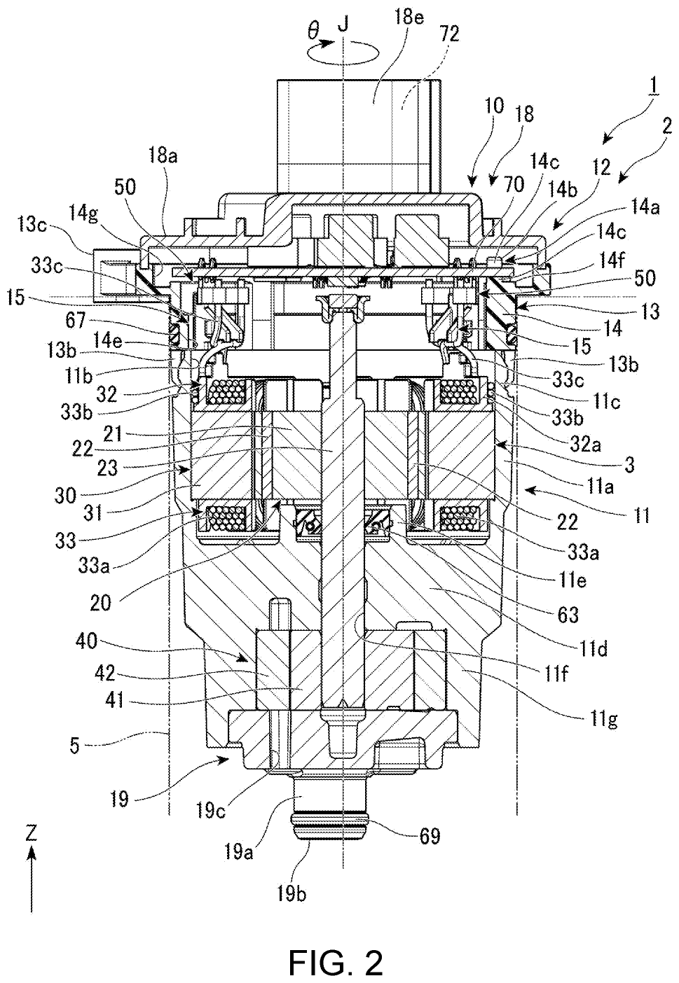

A pump 1 of this embodiment shown in FIG. 1 is an electric pump that is mounted on equipment installed in a vehicle. The equipment on which the pump 1 is to be mounted may be an automatic transmission, or may be a driving device for driving the axle of a vehicle. As shown in FIG. 2, the equipment on which the pump 1 is to be mounted is called a mounted body 5. The pump 1 is, for example, an electric oil pump that supplies oil to the equipment installed in a vehicle.

The pump 1 includes a motor 2 and a pump mechanism 40. The motor 2 includes a housing 10, a motor part 3, a circuit board 70, a connection terminal 50, and a sealer 63.

The housing 10 accommodates the motor part 3, the circuit board 70, the sealer 63, and the pump mechanism 40 inside. The housing 10 has a first housing 11, a second housing 12, and a pump cover 19. The first housing 11, the second housing 12 and the pump cover 19 are separate members from each other. The second housing 12 is arranged on the upper side of the first housing 11, namely the axial one side. The pump cover 19 is fixed to the lower side of the first housing 11.

The first housing 11 is substantially cylindrical in shape centered on the central axis J and extending in the axial direction. The first housing 11 has a peripheral wall 11a, a bottom 11d, and a pump mechanism accommodator 11g.

The peripheral wall 11a accommodates the motor part 3 and the sealer 63 inside. The peripheral wall 11a has a cylindrical shape centered on the central axis J and extending in the axial direction. The end on the upper side of the peripheral wall 11a is the end on the upper side of the first housing 11. The peripheral wall 11a has a first opening 11b and a recess 11c, which are open at the upper side, namely the axial one side. The recess 11c is a groove that is recessed toward the radially inner side from the outer peripheral surface of the peripheral wall 11a. The recess 11c is provided at the upper portion of the peripheral wall 11a. In this embodiment, the recess 11c is provided all around the outer peripheral surface of the peripheral wall 11a.

The bottom 11d has a substantially annular shape centered on the central axis J. The radial outer edge of the surface of the bottom 11d facing the upper side is connected to the lower end of the peripheral wall 11a in the axial direction. A sealer holder 11e and a via hole 11f are provided in the bottom 11d. The sealer holder 11e protrudes toward the upper side from a surface of the bottom 11d facing the upper side. The sealer holder 11e has a cylindrical shape centered on the central axis J. The sealer 63 is held on the inner peripheral surface of the sealer holder 11e. The via hole 11f is a hole that penetrates the bottom 11d in the axial direction. When viewed from the axial direction, the via hole 11f has a circular shape centered on the central axis J.

The pump mechanism accommodator 11g accommodates the pump mechanism 40 therein. The pump mechanism accommodator 11g has a cylindrical shape centered on the central axis J and open at the lower side. The upper end of the pump mechanism accommodator 11g is connected to the lower end of the bottom 11d in the axial direction.

The pump cover 19 has a substantially circular plate shape centered on the central axis J. The pump cover 19 is arranged on the lower side of the pump mechanism 40. The pump cover 19 is fixed to a lower portion in an inner peripheral surface of the pump mechanism accommodator 11g. The pump cover 19 blocks the opening of the pump mechanism accommodator 11g from the lower side. A sucker 19a, a suction port 19b, and a discharge port 19c are provided in the pump cover 19.

The sucker 19a has a columnar shape that protrudes toward the lower side from the pump cover 19. A groove is defined on the outer peripheral surface of the sucker 19a, and an O-ring 69 is fitted into the groove. The suction port 19b is a hole that penetrates the pump cover 19 and the sucker 19a in the axial direction. The discharge port 19c is a hole that penetrates the pump cover 19 in the axial direction. Each of the suction port 19b and the discharge port 19c connects the inside of the pump mechanism accommodator 11g and the outside of the pump 1. In this embodiment, oil is sucked into the pump mechanism accommodator 11g via the suction port 19b, and the oil is discharged to the outside of the pump 1 via the discharge port 19c.

The second housing 12 accommodates the circuit board 70 and the connection terminal 50 inside. The second housing 12 is fixed to the upper end of the first housing 11. The second housing 12 blocks the first opening 11b from the upper side. The second housing 12 has a substantially cylindrical shape centered on the central axis J and extending in the axial direction. The second housing 12 has a bus base 13, and a lid 18.

The bus base 13 has a substantially cylindrical shape that surrounds the circuit board 70 and the connection terminal 50 from the radially outer side. The bus base 13 is arranged between the first housing 11 and the lid 18 in the axial direction. In this embodiment, the bus base 13 is made of resin. The bus base 13 is fixed to the upper end of the first housing 11. The bus base 13 has a board accommodator 14, a board holding part 14a, a claw 13b, a flange 13c, and a terminal holding part 15. That is, the second housing 12 has the board accommodator 14, the board holding part 14a, the flange 13c, and the terminal holding part 15.

The board accommodator 14 has a cylindrical shape that extends in the axial direction. In this embodiment, the board accommodator 14 has a substantially cylindrical shape centered on the central axis J and open at the upper side and the lower side. The board accommodator 14 surrounds the circuit board 70 from the radially outer side. The board accommodator 14 accommodates the circuit board 70. The board accommodator 14 has a second opening 14e that is open at the lower side, namely the axial other side, and a third opening 14g that is open at the upper side. The inside of the first housing 11 and the inside of the second housing 12 are connected to each other via the first opening 11b and the second opening 14e. A step having a step surface 14f facing the upper side is provided on the inner side surface of the board accommodator 14. The outer peripheral surface of the board accommodator 14 is exposed to the outside of the pump 1 and the motor 2. The outer peripheral surface of the board accommodator 14 constitute a part of the outer peripheral surface of the second housing 12. A groove is defined on the outer peripheral surface of the board accommodator 14, and an O-ring 67 is fitted into the groove.

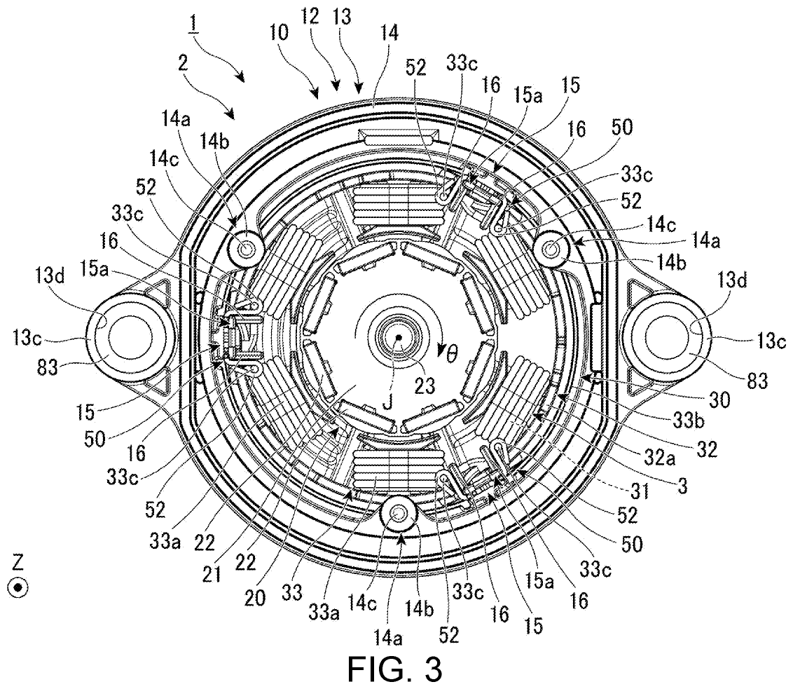

The board holding part 14a holds the circuit board 70. The board holding part 14a protrudes toward the upper side from the step surface 14f. As shown in FIG. 3, in this embodiment, the bus base 13 has multiple board holding parts 14a. In this embodiment, the bus base 13 has three board holding parts 14a. The board holding parts 14a are arranged at substantially equal intervals from each other along the circumferential direction. Each board holding part 14a has a supporter 14b, and an insertion part 14c. As shown in FIG. 2, the supporter 14b has a circular plate shape that protrudes toward the upper side from the step surface 14f, and the plate surface of the supporter 14b faces the axial direction. The insertion part 14c has a columnar shape that protrudes toward the upper side from the supporter 14b. As shown in FIG. 3, the outer diameter of the insertion part 14c is smaller than the outer diameter of the supporter 14b.

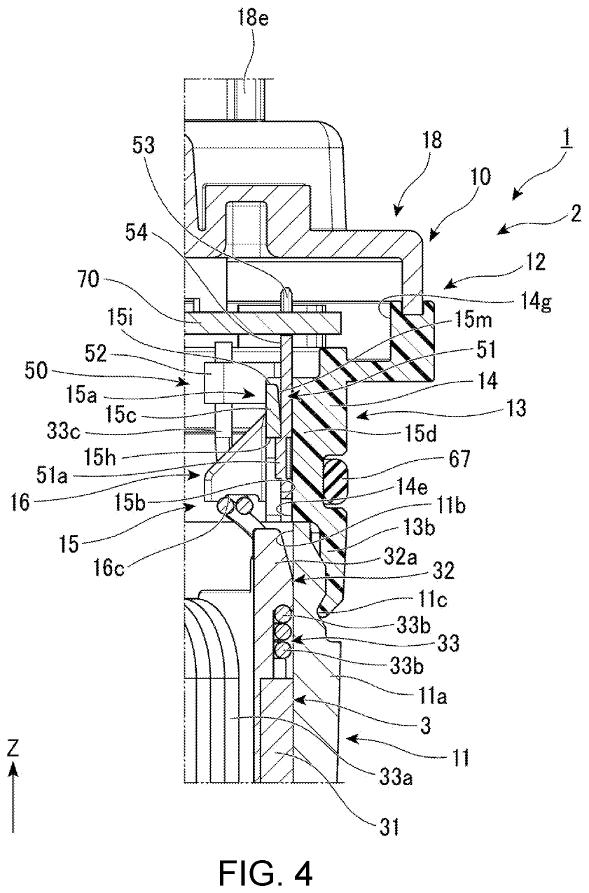

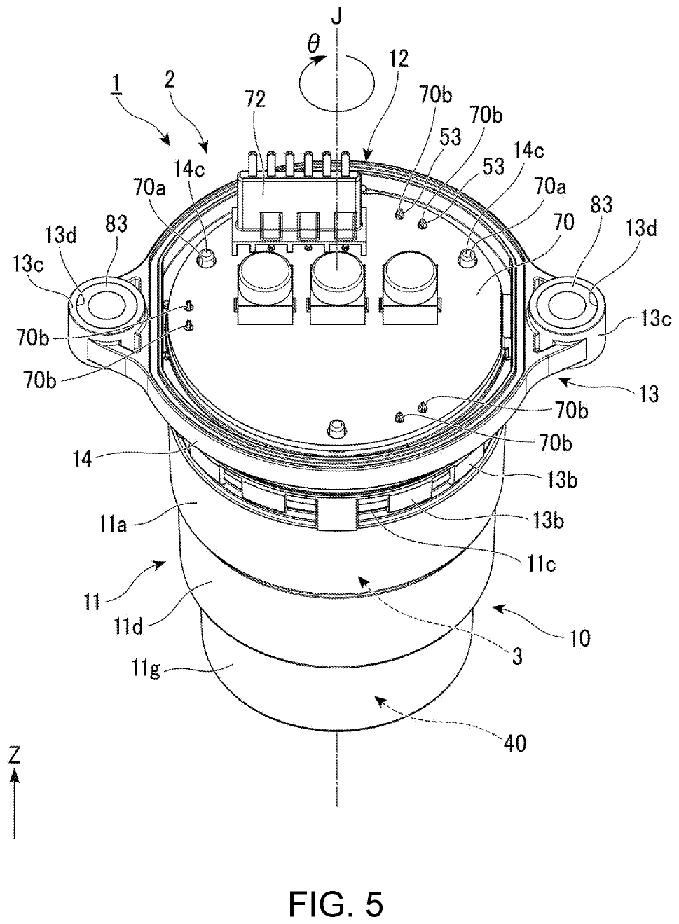

As shown in FIG. 4, the claw 13b protrudes toward the lower side from the board accommodator 14. The claw 13b is arranged further on the radially outer side than the peripheral wall 11a. The tip of the claw 13b protrudes toward the radially inner side. As shown in FIG. 5, in this embodiment, the bus base 13 has multiple claws 13b. Although not shown, in this embodiment, the bus base 13 has fourteen claws 13b. The claws 13b are arranged at intervals from each other along the circumferential direction. As shown in FIG. 4, the tip of each claw 13b is located inside the recess 11c of the first housing 11. Each claw 13b is elastically deformable toward the radially inner side, so it is possible to prevent the tip of each claw 13b from falling off from the inside of the recess 11c. Thereby, the bus base 13 is fixed to the first housing 11.

As shown in FIG. 5, the flange 13c protrudes toward the radially outer side from the board accommodator 14. When viewed from the axial direction, the flange 13c has a substantially triangular shape with one angle protruding toward the radially outer side. A flange hole 13d penetrating in the axial direction is provided in the flange 13c. A cylindrical collar 83 extending in the axial direction is fixed in the flange hole 13d. In this embodiment, the bus base 13 has multiple flanges 13c. In this embodiment, the bus base 13 has two flanges 13c. Each flange 13c is arranged at a position facing to each other in the radial direction. When a bolt (not shown) is passed through the inside of the collar 83 from the upper side, and the bolt is screwed into a screw hole (not shown) provided in the mounted body 5 shown in FIG. 2, each flange 13c is fixed to the mounted body 5. Thereby, the motor 2 and the pump 1 are fixed to the mounted body 5.

As shown in FIG. 2, the terminal holding part 15 is arranged on the radially inner side of the board accommodator 14. The terminal holding part 15 is arranged further on the upper side, namely the axial one side, than a stator core 31 of a stator 30 to be described later. As shown in FIG. 3, the terminal holding part 15 is connected to the inner side surface of the board accommodator 14 in the radial direction. In this embodiment, the bus base 13 has multiple terminal holding parts 15. In this embodiment, the bus base 13 has three terminal holding parts 15. The terminal holding parts 15 are arranged at substantially equal intervals from each other along the circumferential direction. Each terminal holding part 15 has a body 15a, and a protrusion 16.

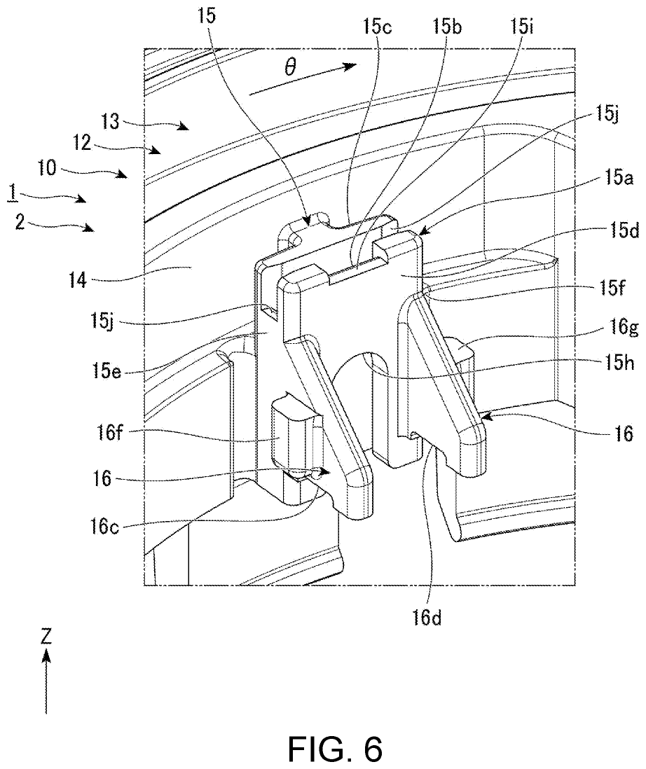

As shown in FIG. 6, the body 15a protrudes toward the radially inner side from the inner side surface of the board accommodator 14. The body 15a has a substantially rectangular parallelepiped shape that extends in the axial direction. The shape of the body 15a is not limited to a substantially rectangular parallelepiped shape, but may be other shapes such as a columnar shape that extends in the axial direction. Two of the outer side surfaces in the outer side surfaces of the body 15a face the radial direction. The body 15a has a holding hole 15b, a first recess 15h, a third recess 15i, and a fourth recess 15j.

The holding hole 15b is a hole that penetrates the body 15a in the axial direction. When viewed from the axial direction, the holding hole 15b has a rectangular shape with a short side extending in the radial direction. The body 15a includes a first body 15c, a second body 15d, a third body 15e, and a fourth body 15f. The first body 15c is the portion in the body 15a further on the radially outer side than the holding hole 15b. The first body 15c is connected to the inner side surface of the board accommodator 14. The second body 15d is the portion in the body 15a further on the radially inner side than the holding hole 15b. The first body 15c and the second body 15d each have a plate shape that extends in the direction perpendicular to the radial direction. When viewed from the radial direction, the first body 15c and the second body 15d each have a substantially rectangular shape. The third body 15e is the portion in the body 15a further on the circumferential other side (−θ side) than the holding hole 15b. The fourth body 15f is the portion in the body 15a further on the circumferential one side (+θ side) than the holding hole 15b. The third body 15e and the fourth body 15f each have a plate shape that extends in the direction perpendicular to the circumferential direction. When viewed from the circumferential direction, the third body 15e and the fourth body 15f each have a substantially rectangular shape. The third body 15e is connected to the edges of the first body 15c and the second body 15d on the circumferential other side, and the fourth body 15f is connected to the edges of the first body 15c and the second body 15d on the circumferential one side.

The first recess 15h is a hole that is recessed toward the upper side from the lower end of the second body 15d. That is, the first recess 15h is a hole in the body 15a that is recessed toward the upper side from the lower side and is further on the radially inner side than the holding hole 15b. The first recess 15h is open at both the radially inner side and the radially outer side.

The inside of the first recess 15h is connector to the inside of the holding hole 15b. When viewed from the radial direction, the lower portion of the first recess 15h has a rectangular shape that extends in the axial direction. When viewed from the radial direction, the upper portion of the first recess 15h has a semicircular shape that protrudes toward the upper side.

The third recess 15i is a hole that is recessed toward the lower side from a surface of the second body 15d facing the upper side, namely the axial other side. The third recess 15i is open at both the radially inner side and the radially outer side. The inside of the third recess 15i is connector with the inside of the holding hole 15b. When viewed from the radial direction, the third recess 15i has a rectangular shape. When viewed from the axial direction, the third recess 15i overlaps the first recess 15h.

As shown in FIG. 4, the surface in the inner side surfaces of the holding hole 15b facing the radially outer side has an inclined surface 15m located on the radially outer side as it moves from the edge of the third recess 15i on the radially outer side toward the lower side, namely the axial other side. That is, the inner side surface of the holding hole 15b has the inclined surface 15m. The end of the lower side of the inclined surface 15m is connected to the surface of the first recess 15h facing the lower side.

As shown in FIG. 6, the fourth recess 15j is a hole that is recessed toward the lower side from the surface of the body 15a facing the upper side. The fourth recess 15j is open at both sides in the circumferential direction. The inside of the fourth recess 15j is connector to the inside of the holding hole 15b. When viewed from the circumferential direction, the fourth recess 15j has a substantially rectangular shape. The end of the lower side of the fourth recess 15j is located further on the upper side than the end of the upper side of the first recess 15h. In this embodiment, the body 15a has two fourth recesses 15j. One fourth recess 15j is provided in the third body 15e. The other fourth recess 15j is provided in the fourth body 15f.

The protrusion 16 has a plate shape that protrudes toward the radially inner side from the body 15a. The plate surface of the protrusion 16 faces the circumferential direction. When viewed from the circumferential direction, the protrusion 16 has a trapezoidal shape, the axial size of which decreases as it moves from the body 15a toward the radially inner side. When viewed from the circumferential direction, the end of the upper side of the protrusion 16 is located at the lower side as it moves from the body 15a toward the radially inner side. When viewed from the circumferential direction, the end of the lower side of the protrusion 16 extends in the radial direction. In this embodiment, the terminal holding part 15 has two protrusions 16.

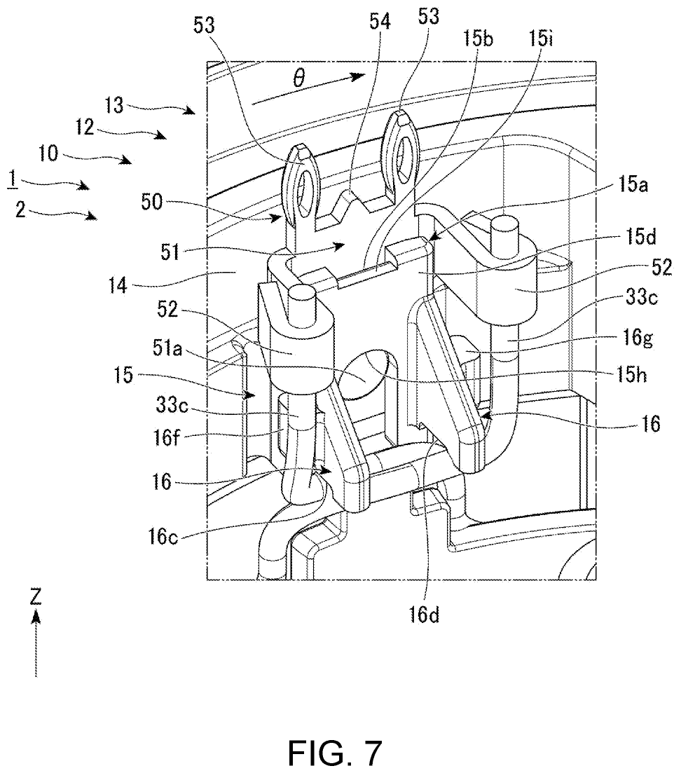

One protrusion 16 protrudes toward the radially inner side from the edge of the second body 15d on the circumferential other side (−θ side). A second recess 16c and a restriction 16f are provided in one protrusion 16. The second recess 16c is a hole recessed toward the upper side, namely the axial one side, from the surface of one protrusion 16 facing the lower side, namely the axial other side. The second recess 16c is open at both sides in the circumferential direction. The restriction 16f protrudes toward the circumferential other side from a surface of one protrusion 16 facing the circumferential other side. As shown in FIG. 7, the surface of one protrusion 16 facing the circumferential other side is the surface facing a coil lead-out wire 33c in the circumferential direction. As shown in FIG. 6, in this embodiment, the restriction 16f is has substantially rectangular parallelepiped shape that extends in the axial direction. The restriction 16f is arranged further on the upper side than the second recess 16c. The surface of the restriction 16f facing the radially inner side is located further on the radially outer side than the end of the second recess 16c on the radially inner side.

The other protrusion 16 protrudes toward the radially inner side from the edge of the second body 15d on the circumferential one side (+θside). A second recess 16d and a restriction 16g are provided in the other protrusion 16. The second recess 16d is a hole that is recessed toward the upper side from the surface of the other protrusion 16 facing the lower side. The second recess 16d is open at both sides in the circumferential direction. The restriction 16g protrudes toward the circumferential one side from the surface of the protrusion 16 facing the circumferential one side. As shown in FIG. 7, the surface of the other protrusion facing the circumferential one side faces the coil lead-out wire 33c in the circumferential direction. As shown in FIG. 6, in this exemplary embodiment, the restriction 16g has a substantially rectangular parallelepiped shape that extends in the axial direction. The restriction 16g is arranged further on the upper side than the second recess 16d. The surface of the restriction 16g facing the radially inner side is located further on the radially outer side than the end of the second recess 16d on the radially inner side.

As shown in FIG. 2, the lid 18 has a lid part 18a and a connector accommodator 18e. The lid part 18a has a substantially cylindrical shape centered on the central axis j and protruding in the axial direction. The lid part 18a is open at the lower side. The lid part 18a is fixed to the upper end of the bus base 13. Thereby, the lid 18 is fixed to the bus base 13. The lid part 18a blocks the third opening 14g from the upper side.

As shown in FIG. 1, the connector accommodator 18e protrudes toward the upper side from the lid part 18a. The connector accommodator 18e has a substantially square tubular shape with openings at both the upper side and the lower side. The inside of the connector accommodator 18e is connected to the inside of the lid 18 via a hole (not shown) penetrating the lid part 18a in the axial direction.

As shown in FIG. 2, the motor part 3 is accommodated in the first housing 11 and the bus base 13. In the axial direction, the motor part 3 is arranged further on the lower side than the circuit board 70 and further on the upper side than the pump mechanism 40. The motor part 3 has a rotor 20 and the stator 30.

The rotor 20 is rotatable around the central axis j. The rotor 20 has a rotor core 21, a magnet 22, and a shaft 23. The magnet 22 and the shaft 23 are fixed to the rotor core 21. The rotor 20 is supported by the inner peripheral surface of the via hole 11f that supports the support shaft 23 so as to be rotatable around the central axis j. The shaft 23 has a columnar shape centered on the central axis J and extending in the axial direction. The shaft 23 is passed through the via hole 11f in the axial direction, and is arranged to cross the inside of the peripheral wall 11a and the inside of the pump mechanism accommodator 11g.

The stator 30 is arranged on the radially outer side of the rotor 20. The stator 30 faces the rotor 20 with a gap in the radial direction. The stator 30 has the stator core 31, an insulator 32 and a coil 33.

The stator core 31 has an annular shape that surrounds the rotor core 21 from the radially outer side. The outer peripheral surface of the stator core 31 is fixed to the peripheral wall 11a of the first housing 11. In this embodiment, the stator core 31 is press-fitted into the peripheral wall 11a. The stator core 31 may be fixed to the peripheral wall 11a by other methods such as adhesion. The insulator 32 is attached to the stator core 31. The insulator 32 is arranged between the stator core 31 and the coil 33. The insulator 32 insulates the stator core 31 and the coil 33. The insulator 32 has an annular wall 32a that protrudes toward the upper side. The annular wall 32a is arranged between the stator core 31 and the terminal holding part 15 in the axial direction. As shown in FIG. 3, the annular wall 32a has an annular shape centered on the central axis J. As shown in FIG. 2, the annular wall 32a faces the peripheral wall 11a in the radial direction.

The coil 33 is electrically connected to the circuit board 70 via the connection terminal 50. Power is supplied to the coil 33 from the circuit board 70 via the connection terminal 50. The coil 33 has multiple coil bodies 33a, transition wires 33b, and coil lead-out wires 33c.

The multiple coil bodies 33a are attached to the stator core 31. As shown in FIG. 3, the multiple coil bodies 33a are arranged further on the radially inner side than the annular wall 32a. In this embodiment, the coil 33 has six coil bodies 33a. The coil bodies 33a are arranged at intervals from each other along the circumferential direction.

The transition wire 33b connects a coil body 33a and the coil lead-out wire 33c. Although not shown, the transition wire 33b led out from the coil body 33a is passed in the radial direction via a hole (not shown) that penetrates the annular wall 32a in the radial direction, and, as shown in FIG. 4, is arranged on the radially outer side of the annular wall 32a and the radially inner side of the peripheral wall 11a. The transition wire 33b extends in the circumferential direction along the surface of the annular wall 32a facing the radially outer side. Although not shown, in this embodiment, six transition wires 33b are provided. Each transition wire 33b is connected to the coil body 33a different from each other. When viewed from the axial direction, the transition wire 33b overlaps the holding hole 15b of the terminal holding part 15.

The coil lead-out wire 33c is connected to the connection terminal 50. The coil lead-out wire 33c is led out from the coil body 33a toward the upper side, namely the axial one side via the transition wire 33b. As shown in FIG. 3, in this embodiment, the coil 33 has six coil lead-out wires 33c. Each coil lead-out wire 33c is connected to a different coil body 33a via a different transition wire 33b. The path for arranging the coil lead-out wire 33c and the connection structure between the coil lead-out wire 33c and the connection terminal 50 will be described in detail later.

As shown in FIG. 2, the sealer 63 is held on the inner peripheral surface of the sealer holder 11e. The sealer 63 is arranged further on the lower side than the rotor core 21. In this embodiment, the sealer 63 is a lip seal having a lip on the radially inner side. The lip of the sealer 63 contacts the outer peripheral surface of the shaft 23. Thereby, the sealer 63 seals between the shaft 23 and the first housing 11.

The pump mechanism 40 is accommodated inside the pump mechanism accommodator 11g. The pump mechanism 40 has an inner rotor 41 and an outer rotor 42. The inner rotor 41 is connected to the portion in the shaft 23 that protrudes into the pump mechanism accommodator 11g. Thereby, the pump mechanism 40 is connected to the rotor 20. The inner rotor 41 has an annular shape that surrounds the shaft 23. The outer rotor 42 has an annular shape that surrounds the inner rotor 41. The inner rotor 41 and the outer rotor 42 are engaged with each other. Thereby, when the rotor 20 rotates around the central axis J, the inner rotor 41 and the outer rotor 42 also rotate around the central axis J.

The circuit board 70 is electrically connected to the coil 33 via the connection terminal 50. The circuit board 70 controls the power supplied to the coil 33. The circuit board 70 is arranged on the upper side, namely the axial one side, of the motor part 3. The circuit board 70 is arranged on the lower side of the lid 18. As described above, the circuit board 70 is accommodated inside the board accommodator 14. The circuit board 70 has a plate shape that extends in the direction perpendicular to the axial direction. As shown in FIG. 5, when viewed from the axial direction, the circuit board 70 has a substantially circular shape. Multiple first via holes 70a and multiple second via holes 70b are provided in the circuit board 70. Moreover, a connector 72 is mounted on the circuit board 70.

Each of the multiple first via holes 70a is a hole penetrating the circuit board 70 in the axial direction. In this embodiment, three first via holes 70a are provided. The first via holes 70a are arranged at approximately equal intervals from each other along the circumferential direction. The insertion part 14c of the board holding part 14a is passed through each first via hole 70a in the axial direction. In this embodiment, the insertion part 14c is fitted into each first via hole 70a. Thereby, the circumferential position and radial position of the circuit board 70 with respect to the second housing 12 are determined. As shown in FIG. 2, the surface facing the lower side of the circuit board 70 is supported in the axial direction by the supporter 14b of the board holding part 14a. Thereby, the axial position of the circuit board 70 with respect to the second housing 12 is determined. Thereby, the circuit board 70 is held in the board holding part 14a.

As shown in FIG. 5, the multiple second via holes 70b are holes penetrating the circuit board 70 in the axial direction. The second via hole 70b is, for example, a through hole. A conductive copper foil is provided in the inner side surface of the second via hole 70b. In this embodiment, six second via holes 70b are provided. In this embodiment, each pair of the second via holes 70b are arranged at approximately equal intervals from each other along the circumferential direction. Two second via holes 70b constituting a pair of second via holes 70b are arranged at intervals from each other in the circumferential direction.

The connector 72 electrically connects an external device (not shown) that supplies power to the motor 2 and the circuit board 70. The connector 72 is mounted on the surface of the circuit board 70 facing the upper side and protrudes toward the upper side. The upper portion of the connector 72 is arranged inside the connector accommodator 18e shown in FIG. 2.

The connection terminal 50 electrically connects the coil 33 and the circuit board 70. In the axial direction, the connection terminal 50 is arranged between the stator 30 and the circuit board 70. As shown in FIG. 3, the connection terminal 50 is held in the terminal holding part 15 of the second housing 12. In this embodiment, the motor part 3 has multiple connection terminals 50. In this embodiment, the motor part 3 has three connection terminals 50. The connection terminals 50 are arranged at approximately equal intervals along the circumferential direction. The connection terminal 50 has electrical conductivity. In this embodiment, the connection terminal 50 is made of metal. As shown in FIG. 7, the connection terminal 50 has a terminal body 51, a first connection part 52, a second connection part 53 and a board supporter 54.

The terminal body 51 has a plate shape that extends in the axial direction. The plate surface of the terminal body 51 faces the radial direction. When viewed from the radial direction, the terminal body 51 has a substantially rectangular shape. As shown in FIG. 4, the portion of the lower side, namely the axial other side, of the terminal body 51 is arranged inside the holding hole 15b. The lower end of the terminal body 51 is located further on the upper side than the lower end of the body 15a. As shown in FIG. 7, the upper portion of the terminal body 51 is located further on the upper side than the body 15a. A body bump 51a is provided in the terminal body 51.

As shown in FIG. 4, the body bump 51a is the portion of the terminal body 51 that protrudes toward the radially inner side. In this embodiment, the body bump 51a is provided by pressing the terminal body 51. As shown in FIG. 7, when viewed from the radial direction, the body bump 51a has a substantially circular shape. The body bump 51a is arranged in the first recess 15h. In the radial direction, the distance between the surface of the terminal body 51 facing the radially outer side and the surface of the body bump 51a facing the radially inner side is larger than the radial dimension of the holding hole 15b.

According to this embodiment, the body 15a has the holding hole 15b penetrating the body 15a in the axial direction, and the first recess 15h in the body 15a that is recessed toward the upper side from the lower side further on the radially inner side than the holding hole 15b. The body bump 51a protruding toward the radially inner side is provided in the terminal body 51 of the connection terminal 50. The lower portion of the terminal body 51 is arranged inside the holding hole 15b. The body bump 51a is arranged in the first recess 15h. Thus, by the surface facing the circumferential direction in the inner side surface of the first recess 15h, it is possible to prevent the body bump 51a from moving in the circumferential direction. Thereby, the circumferential position of the connection terminal 50 with respect to the second housing 12 is determined. Moreover, by contacting the body bump 51a with the surface facing the lower side in the inner side surface of the first recess 15h, it is possible to prevent the connection terminal 50 from falling off to the upper side. Moreover, by the surface facing the radial direction in the inner side surface of the holding hole 15b, it is possible to prevent the terminal body 51 from moving in the radial direction. Thereby, the radial position of the connection terminal 50 with respect to the second housing 12 is determined. Moreover, as described above, the circumferential position and radial position of the circuit board 70 with respect to the second housing 12 are determined by the board holding part 14a provided in the second housing 12. Thus, via the second housing 12, it is possible to determine the circumferential position and the radial position of the connection terminal 50 with respect to the circuit board 70 with high accuracy, so the connection terminal 50 is able to be connected to the circuit board 70 easily. Thus, it is possible to suppress the increase in the assembly man-hours of the motor 2 and the pump 1.

Furthermore, in this embodiment, the outer diameter of the body bump 51a is approximately the same as the dimension of the first recess 15h in the direction perpendicular to the radial direction. Thus, it is possible to determine the circumferential position of the connection terminal 50 with respect to the terminal holding part 15 with higher accuracy, and so it is possible to determine the circumferential position of the connection terminal 50 with respect to the circuit board 70 with higher accuracy. Thus, it is possible to better suppress the increase in the assembly man-hours of the motor 2 and the pump 1.

Moreover, in this embodiment, the body bump 51a is able to contact with the inner side surface of the semicircular shaped portion in the first recess 15h in the axial direction. Thus, it is possible to prevent the connection terminal 50 from moving toward the upper side with respect to the terminal holding part 15. Thereby, it is possible prevent the axial position of the connection terminal 50 with respect to the circuit board 70 from being deviated, so the connection terminal 50 is able to be connected to the circuit board 70 more easily. Thus, it is possible to better suppress the increase in manufacturing man-hours of the motor 2 and the pump 1.

Furthermore, in this embodiment, in the process of mounting the connection terminal 50 to the terminal holding part 15, the body bump 51a is able to be arranged in the first recess 15h by a simple work of inserting the terminal body 51 into the holding hole 15b from the upper side of the terminal holding part 15, and so the connection terminal 50 is able to be mounted on the terminal holding part 15. Thereby, it is possible to simplify the work of mounting the connection terminal 50 to the terminal holding part 15, and so it is better suppress the increase in manufacturing man-hours of the motor 2 and the pump 1.

According to this embodiment, the body 15a has the third recess 15i that is recessed toward the lower side, namely the axial other side, from the portion that overlaps the first recess 15h when viewed from the axial direction, of the surface of the body 15a facing the upper side, namely the axial one side. Thus, in the process of mounting the connection terminal 50 to the terminal holding part 15, when the terminal body 51 is inserted into the holding hole 15b from the upper side of the terminal holding part 15, the body bump 51a is able to be reliably arranged in the first recess 15h by the work of aligning the circumferential position of the body bump 51a with the circumferential position of the third recess 15i and moving the connection terminal 50 toward the lower side. Thus, the connection terminal 50 is able to be mounted to the terminal holding part 15 more easily, and so it is possible to better suppress the increase in manufacturing man-hours of the motor 2 and the pump 1.

Moreover, according to this embodiment, as shown in FIG. 4, the inner side surface of the holding hole 15b has the inclined surface 15m located on the radially outer side as it moves from the edge of the third recess 15i on the radially outer side toward the lower side. Thus, in the process of mounting the connection terminal 50 to the terminal holding part 15, by inserting the terminal body 51 into the holding hole 15b while making the lower end of the body bump 51a along the inclined surface 15m, it is possible to prevent the body bump 51a from being caught on the surface of the third recess 15i facing the upper side when the terminal body 51 is inserted into the holding hole 15b. Moreover, by making the body bump 51a toward the lower side move along the inclined surface 15m, the body bump 51a is made elastically deformable toward the radially outer side smoothly. Thereby, it is easier to insert the terminal body 51 into the holding hole 15b. Thus, the connection terminal 50 is able to be more easily mounted to the terminal holding part 15, and so it is possible to better suppress the increase in manufacturing man-hours of the motor 2 and the pump 1.

As shown in FIG. 7, the first connection part 52 is connected to the coil lead-out wire 33c. The first connection part 52 has a plate shape that protrudes toward the radially inner side from the terminal body 51. That is, the first connection part 52 is connected to the terminal body 51. The plate surface of the first connection part 52 faces the direction perpendicular to the axial direction. In this embodiment, the connection terminal 50 has a pair of first connection parts 52. When viewed from the axial direction, each of the pair of first connection parts 52 has a U-shape that surrounds different coil lead-out wires 33c. One first connection part 52 protrudes toward the radially inner side from the edge of the terminal body 51 on the circumferential other side (−θside). The other first connection part 52 protrudes toward the radially inner side from the edge of the terminal body 51 on the circumferential one side (+0 side). Although not shown, the portion of one first connection part 52 on the radially outer side contacts in the axial direction with the surface of the fourth recess 15j of the third body 15e facing the upper side, as shown in FIG. 6. Although not shown, the portion of the other first connection part 52 on the radially outer side contacts in the axial direction with the surface of the fourth recess 15j of the fourth body 15f facing the upper side. Thereby, the axial position of the connection terminal 50 with respect to the terminal holding part 15 is determined.

As shown in FIG. 7, each opening of each first connection part 52 faces the radially outer side. Different coil lead-out wires 33c are inserted into each of the first connection parts 52, respectively. Each first connection part 52 is riveted together with the coil lead-out wire 33c from both sides in the circumferential direction such that the opening is narrowed, and the coil lead-out wire 33c is held in each first connection part 52. Furthermore, in this embodiment, the first connection part 52 and the coil lead-out wires 33c are joined by welding, such as fusion welding. Thereby, the mutually different coil lead-out wires 33c are more stably connected to the first connection part 52. Thus, two coil lead-out wires 33c are stably connected to each connection terminal 50.

The second connection part 53 has a plate shape that protrudes toward the upper side, namely the axial one side, from the terminal body 51. The plate surface of the second connection part 53 faces the radial direction. When viewed from the radial direction, the second connection part 53 has a substantially elliptical shape with its long axis extending in the axial direction. A hole penetrating the second connection part 53 in the radial direction is provided in the second connection part 53. When viewed from the radial direction, the hole has a substantially elliptical shape with its long axis extending in the axial direction. Since a hole is provided in the second connection part 53, the second connection part 53 is elastically deformable in the circumferential direction. In this embodiment, the connection terminal 50 has two second connection parts 53. One second connection part 53 protrudes toward the upper side from the edge of the terminal body 51 on the circumferential other side (−θside). The other second connection part 53 protrudes toward the upper side from the edge of the terminal body 51 on the circumferential one side (+θ side). The two second connection parts 53 are arranged at intervals from each other in the circumferential direction.

As shown in FIG. 5, the second connection parts 53 of each connection terminal 50 is passed through the second via holes 70b of the circuit board 70 in the axial direction. Each second connection part 53 is press-fitted into the second via hole 70b. As described above, since the second connection parts 53 is elastically deformable in the circumferential direction, each second connection part 53 is fixed to the second via hole 70b by the restoring force of the second connection parts 53. Thereby, each second connection part 53 is connected to the circuit board 70. As described above, the first connection part 52 of each connection terminal 50 is connected to the coil lead-out wire 33c. Thereby, each connection terminal 50 electrically connects the coil 33 and the circuit board 70.

According to this embodiment, the connection terminal 50 has the second connection part 53 protruding toward the upper side, namely axial one side, from the terminal body 51, and the second connection part 53 is connected to the circuit board 70. Thus, in the process of connecting the connection terminal 50 and the circuit board 70, the second connection part 53 is able to be fixed in the second via hole 70b of the circuit board 70 by a simple work of moving the circuit board 70 toward the lower side from the upper side of the connection terminal 50 held by the terminal holding part 15 in advance. Thus, the connection terminal 50 and the circuit board 70 are able to be easily connected, so it is possible to suppress an increase in the assembly man-hours of the motor 2 and the pump 1.

As shown in FIG. 7, the board supporter 54 protrudes toward the upper side from the terminal body 51. The board supporter 54 is arranged between two second connection parts 53. When viewed from the radial direction, the board supporter 54 has a substantially triangular shape that protrudes toward the upper side. The end of the upper side of the board supporter 54 is located at a power further on the lower side than the upper end of the second connection part 53. Although not shown, the board supporter 54 contacts in the axial direction with the surface of the circuit board 70 facing the lower side. The board supporter 54 supports the circuit board 70 in the axial direction. Thereby, it is possible to improve the position accuracy of the circuit board 70 with respect to the second housing 12 in the axial direction via the connection terminal 50.

As shown in FIG. 4, as described above, the coil lead-out wire 33c is led out toward the upper side, namely the axial one side, from the coil body 33a via the transition wire 33b. More specifically, the coil lead-out wire 33c is led out toward the connection terminal 50 from the transition wire 33b. Thereby, even if the position where the coil lead-out wire 33c is led out from the transition wire 33b deviates from the position of the connection terminal 50 in the circumferential direction and the radial direction, the coil lead-out wire 33c is able to be connected to the connection terminal 50 by appropriately adjusting the direction in which the coil lead-out wire 33c is led out from the transition wire 33b. Since the coil lead-out wire 33c is flexible, it is possible to easily adjust the direction in which the coil lead-out wire 33c is led out from the transition wire 33b.

As shown in FIG. 7, the coil lead-out wire 33c led out from the coil body 33a toward the connection terminal 50 via the transition wire 33b bends toward the upper side after passing through the inner side of the second recess 16c of the one protrusion 16 or the second recess 16d of the other protrusion 16 in the circumferential direction. More specifically, of the two coil lead-out wires 33c connected to the connection terminal 50, one coil lead-out wire 33c is passed through the lower side of the second recess 16d, then passed through the inner side of the second recess 16c from the circumferential one side to the circumferential other side, and bends toward the upper side, namely the axial one side, at the circumferential end of the second recess 16c. After passing through the lower side of the second recess 16c, the other coil lead-out wire 33c is passed through the inner side of the second recess 16d from the circumferential other side to the circumferential one side, and bends toward the upper side at the circumferential end of the second recess 16d.

According to this embodiment, on the facing the lower side of the protrusion 16, namely the axial other side, there are second recesses 16c and 16d which are recessed on the upper side, namely the axial one side and open at both sides in the circumferential direction, and the coil lead-out wire 33c is passed through the inner side of the second recesses 16c and 16d in the circumferential direction, and bends toward the upper side at the circumferential ends of the second recesses 16c and 16d. As a result, it is possible to prevent the coil lead-out wire 33c from moving in the radial direction by the surface of the second recesses 16c and 16d facing the radial direction. Therefore, in the process of connecting the coil lead-out wire 33c to the connection terminal 50, the radial position of the coil lead-out wire 33c with respect to the connection terminal 50 is able to be stabilized. Thus, the coil lead-out wire 33c is able to be easily connected to the connection terminal 50, so it is possible to suppress the increase in manufacturing man-hours of the motor 2 and the pump 1.

Moreover, according to this embodiment, it is possible to bend the coil lead-out wire 33c toward the upper side while hooking the coil lead-out wire 33c at the corner that connects the surface in the inner side surfaces of the second recesses 16c and 16d facing the lower side and the surface of the protrusion 16 facing the circumferential direction. Thus, the coil lead-out wire 33c is able to be easily bent toward the upper side, so it is possible to simplify the work of connecting the coil lead-out wire 33c to the connection terminal 50. Thus, it is possible to better suppress the increase in manufacturing man-hours of the motor 2 and the pump 1.

At the circumferential end of the second recess 16c, one coil lead-out wire 33c bent toward the upper side extends to the upper side along a surface of the restriction 16f facing the radially inner side and is connected to one first connection part 52. At the circumferential end of the second recess 16d, the other coil lead-out wire 33c bent toward the upper side extends to the upper side along a surface of the restriction 16g facing the radially inner side and is connected to the other first connection part 52. Moreover, the surface of the restriction 16f facing the radially inner side may be a flat surface or a curved surface, or may include multiple surfaces.

According to this embodiment, the restrictions 16f and 16g are provided on the surface in the surface of the protrusion 16 facing the circumferential direction, facing the coil lead-out wire 33c in the circumferential direction, and the coil lead-out wire 33c extends to the upper side, namely the axial one side, along the surface of the restrictions 16f and 16g facing the radially inner side. Thus, in the process of connecting the coil lead-out wire 33c to the connection terminal 50, the coil lead-out wire 33c is able to made to be along the surface of the restrictions 16f and 16g facing the radially inner side, while extending to the upper side and, so the radial position of the coil lead-out wire 33c with respect to the first connection part 52 is more stable. Thus, the coil lead-out wire 33c is able to be connected to the connection terminal 50 more easily, so it is possible to better suppress the increase in manufacturing man-hours of the motor 2 and the pump 1.

According to this embodiment, the stator 30 includes the annular stator core 31 fixed to the first housing 11, the coil 33 having the multiple coil bodies 33a attached to the stator core 31, and the insulator 32 arranged between the stator core 31 and the coil 33. The connection terminal 50 electrically connects the coil 33 and the circuit board 70. The second housing 12 has a cylindrical shape that extends in the axial direction, and has the board accommodator 14 for accommodating the circuit board 70, the board holding part 14a for holding the circuit board 70, and the terminal holding part 15 for holding the connection terminals 50. The outer peripheral surface of the board accommodator 14 constitutes a part of the outer peripheral surface of the second housing 12, and the terminal holding part 15 is connected to the inner side surface of the board accommodator 14. In a structure in which the connection terminal 50 connecting the coil 33 and the circuit board 70 is held by, for example, the insulator 32 of the stator 30, when the stator 30 is fixed to the first housing 11 in a state where the circumferential position is displaced with respect to the first housing 11, the circumferential position of the connection terminal 50 is displaced with respect to the circuit board 70. Therefore, in the process of connecting the connection terminal 50 and the circuit board 70, it may be difficult to connect the connection terminal 50 and the circuit board 70. On the other hand, in this embodiment, both the connection terminal 50 and the circuit board 70 are held in the second housing 12, so it is possible to improve the positional accuracy of the connection terminal 50 with respect to the circuit board 70. As a result, it is possible to simply the work of connecting the connection terminal 50 to the circuit board 70. Moreover, even if the stator 30 is fixed to the first housing 11 in a state where the circumferential position is displaced from the first housing 11, the coil lead-out wire 33c is able to be easily connected to the connection terminal 50 by appropriately adjusting the direction in which the flexible coil lead-out wire 33c is lead out, as described above. As a result, it is possible to simplify the work of connecting the coil 33 to the connection terminal 50. According to the above, in this embodiment, even is the stator 30 is fixed to the first housing 11 in a state where the circumferential position is displaced from the first housing 11, it is possible to simplify the work of connecting the coil 33 and the circuit board 70 via the connection terminal 50. Thus, it is possible to suppress the increase in manufacturing man-hours of the motor 2 and the pump 1.

As shown in FIG. 2, in this embodiment, the board accommodator 14 has a cylindrical shape and has a third opening 14g that opens at the upper side. Therefore, in the process of connecting the coil lead-out wire 33c to the connection terminal 50, equipment such as a jig for wiring the coil lead-out wire 33c or a welding machine for joining the coil lead-out wire 33c to the connection terminal 50 is able to be inserted into the board accommodator 14 via the third opening 14g. Thus, the coil lead-out wire 33c is able to be connected to the connection terminal 50 more easily, and so it is possible to better suppress the increase in the assembly man-hours of the motor 2 and the pump 1.

According to this embodiment, the coil 33 has the coil lead-out wire 33c that is lead out from the coil body 33a to the upper side, namely the axial one side and is connected to the connection terminal 50, and the terminal holding part 15 is arranged further on the upper side than the stator core 31. Thus, it is possible to suppress the arrangement of components and the like constituting the motor part 3 of the terminal holding part 15 on the radially inner side. Therefore, in the process of connecting the coil lead-out wire 33c with the connection terminal 50, it is possible to suppress interference between equipment such as a welding machine that joins the coil lead-out wire 33c with the connection terminal 50 and components constituting the motor part 3. Thus, the coil lead-out wire 33c is able to be connected to the connection terminal 50 more easily, so it is possible to better suppress the increase in the assembly man-hours of the motor 2 and the pump 1.

As shown in FIG. 4, according to this embodiment, the coil 33 has the transition wire 33b that extends along the circumferential direction of the insulator 32 on the radially outer side and connects the coil body 33a and the coil lead-out wire 33c, and when viewed from the axial direction, the holding hole 15b overlaps the transition wire 33b. Thus, it is possible to suppress the terminal holding part 15 and the connection terminal 50 from being arranged further on the radially outer side than the stator 30. Thus, it is possible to prevent the second housing 12 from being enlarged in the radial direction, and so it is possible to prevent the motor 2 and the pump 1 from being enlarged in the radial direction.

Moreover, in this embodiment, since the connection terminal 50 is able to be arranged on the upper side of the transition wire 33b, the coil lead-out wire 33c is able to be connected to the connection terminal 50 by leading out the coil lead-out wire 33c from the transition wire 33b only to the upper side. Thus, for example, when viewed from the axial direction, compared with the case where the connection terminal 50 is arrange displaced from the transition wire 33b in the radial direction, there is no need for the work of leading the coil lead-out wire 33c from the transition wire 33b to the upper side and to the radial side, so it is possible to simplify the operation of a jig, for example, for wiring the coil lead-out wire 33c. Thus, the coil lead-out wire 33c is able to be connected to the connection terminal 50 more easily, and so it is possible to better suppress the increase in manufacturing man-hours of the motor 2 and the pump 1.

Moreover, in this embodiment, since the transition wire 33b is arranged on the radially outer side of the insulator 32, it is easy to prevent the coil lead-out wire 33c lead out to the upper side from the transition wire 33b from being arranged on the upper side of the stator core 31. Thus, in the process of connecting the coil lead-out wire 33c to the connection terminal 50, it is easy to insert equipment such as a welding machine for joining the coil lead-out wire 33c to the connection terminal 50 in the space on the upper side of the stator core 31, so it is possibly to connect the coil lead-out wire 33c to the connection terminal 50 easily. Moreover, by extending the transition wire 33b in the circumferential direction so as to be wound around the outer side surface of the insulator 32, it is easy to apply tension to the coil lead-out wire 33c when the coil lead-out wire 33c is led out from the transition wire 33b. Thereby, the coil lead-out wire 33c is able to be connected to the connection terminal 50 more easily, and so it is possible to better suppress the increase in manufacturing man-hours of the motor 2 and the pump 1.

As shown in FIG. 2, according to this embodiment, the board accommodator 14 has the second opening 14e that opens at the lower side, namely the axial other side, and the inside of the first housing 11 and the inside of the second housing 12 are connected to each other via the first opening 11b and the second opening 14e. Thus, compared with the structure in which the coil lead-out wire 33c is lead out from the inside of the first housing 11 to the inside of the second housing 12, by having a partition wall separating the inside of the first housing 11 and the inside of the second housing 12 in the axial direction and by passing the coil lead-out wire 33c through the hole that penetrates the partition wall in the axial direction, the coil lead-out wire 33c is able to be easily connected to the connection terminal 50. Thus, it is possible to suppress the increase in manufacturing man-hours of the motor 2 and the pump 1.

According to this embodiment, the motor 2 is fixed to the mounted body 5, and the second housing 12 has the flange 13c protruding toward the radially outer side from the board accommodator 14, and the flange 13c is fixed to the mounted body 5. As described above, even if the stator 30 is fixed to the first housing 11 in a state where the circumferential position is displaced from the first housing 11, by appropriately adjusting the direction in which the flexible coil lead-out wire 33c is led out, the coil lead-out wire 33c is able to be connected to the connection terminal 50. Therefore, the coil 33 and the circuit board 70 are able to be easily electrically connected, and also it is possible to improve the positional accuracy of the second housing 12 with respect of the first housing 11 on the circumferential direction. Thus, it is possible to improve the positional accuracy of the flange 13c with respect to the mounted body 5 on the circumferential direction, and so it is possible to simplify the work of fixing the motor 2 and the pump 1 to the mounted body 5.

### Second Embodiment

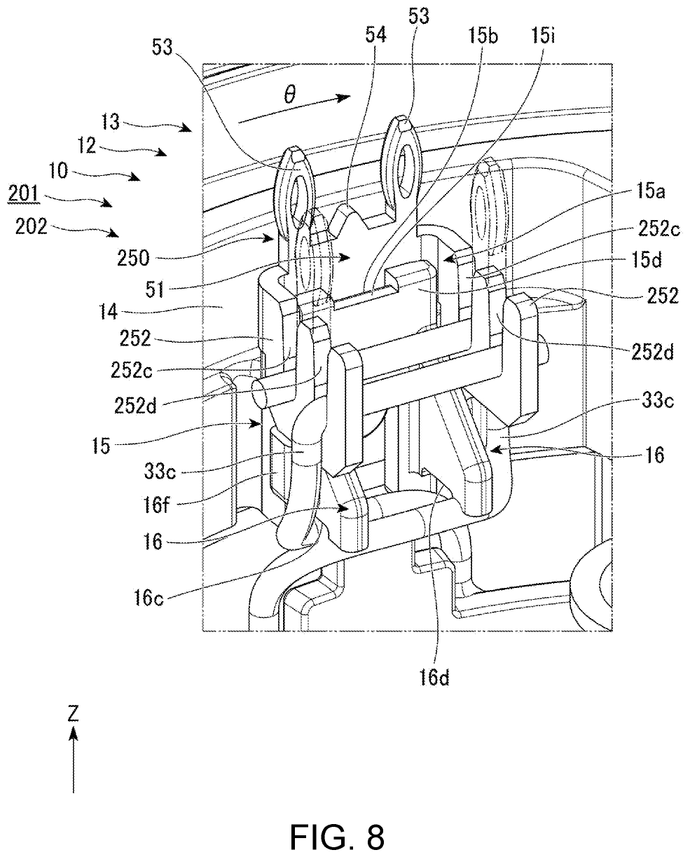

As shown in FIG. 8, a connection terminal 250 of this embodiment has press-contact parts 252c and 252d. In the following description, the same components as those in the first embodiment are given the same reference numerals, and the description thereof is omitted.

As shown in FIG. 8, the connection terminal 250 of this embodiment has the terminal body 51, a first connection part 252, the second connection part 53, and the board supporter 54. The structure of the terminal body 51, the second connection part 53 and the board supporter 54 are the same as those of the terminal body 51, the second connection part 53, and the board supporter 54 in the first embodiment.

The first connection part 252 is connected to the coil lead-out wire 33c. The first connection part 252 has a plate shape that protrudes toward the radially inner side from the terminal body 51. That is, the first connection part 252 is connected to the terminal body 51. The plate surface of the first connection part 252 faces the circumferential direction. In this embodiment, when viewed from the circumferential direction, the first connection part 252 is has a substantially rectangular shape. The shape of the first connection part 252 viewed from the circumferential direction may be other shapes such as a circular shape. The press-contact parts 252c and 252d are provided in the first connection part 252. Each of the press-contact parts 252c and 252d is a hole recessed toward the lower side, namely axial other side, from the end of the upper side of the first connection part 252, namely the axial one side. The press-contact parts 252c and 252d open at the two sides in the circumferential direction, respectively. That is, the press-contact parts 252c and 252d open in the direction perpendicular to the axial direction, respectively. When viewed from the circumferential direction, each of the press-contact parts 252c and 252d has a substantially rectangular shape. The press-contact part 252d is arranged further on the radially inner side than the press-contact part 252c. The press-contact parts 252c and 252d are arranged at intervals from each other in the radial direction.

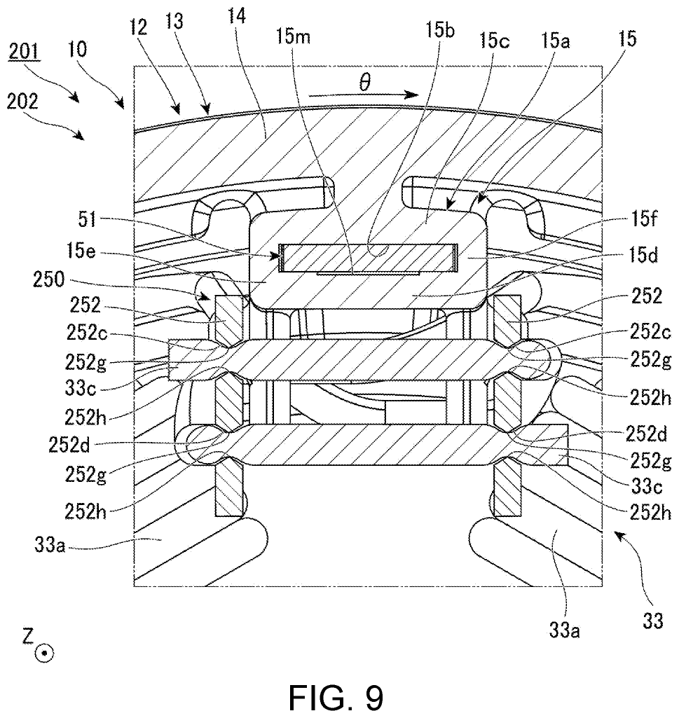

As shown in FIG. 9, when viewed from the axial direction, the surface of each of the press-contact parts 252c and 252d facing the radially inner side is located on the radially inner side as it moves from both ends in the circumferential direction toward the center in the circumferential direction, and a corner 252g is defined at the end on the radially inner side. When viewed from the axial direction, the corner 252g is tapered toward the radially inner side. When viewed from the axial direction, the surface of each of the press-contact parts 252c and 252d facing the radially outer side is located on the radially outer side as it moves from both ends in the circumferential direction toward the center in the circumferential direction, and a corner 252h is defined at the end on the radially outer side. When viewed from the axial direction, the corner 252h is tapered toward the radially outer side. The corners 252g and 252h face each other in the radial direction.

In this embodiment, the connection terminal 250 has a pair of first connection parts 252. One first connection part 252 protrudes toward the radially inner side from the edge of the terminal body 51 on the circumferential other side (−θside). The other first connection part 252 protrudes toward the radially inner side from the edge of the terminal body 51 on the circumferential one side (+θside). The pair of first connection parts 252 are arranged facing each other in the direction perpendicular to the axial direction. In this embodiment, the pair of first connection parts 252 are arranged facing each other in the circumferential direction. Moreover, the number of the first connection parts 252 that the connection terminal 250 has may be one, and in this case, one first connection part 252 is connected to two coil lead-out wires 33c.

As shown in FIG. 8, at the circumferential end of the second recess 16c, one coil lead-out wire 33c bent toward the upper side extends to the upper side along the surface of the restriction 16f facing the radially inner side, and is passed through the inner sides of the press-contact part 252d of the one first connection part 252 and the press-contact part 252d of the other first connection part 252, respectively. That is, the one coil lead-out wire 33c is passed through the inner side of the press-contact part 252d of each of the pair of first connection parts 252. As shown in FIG. 9, in this embodiment, the dimension of the interval between the corners 252g and 252h of the press-contact part 252d is smaller than the diameter of the coil lead-out wire 33c. Thereby, the one coil lead-out wire 33c is pressed into the press-contact part 252d of each of the pair of first connection parts 252.

Similarly, as shown in FIG. 8, the other coil lead-out wire 33c is passed through the inner side of the press-contact part 252c of each of the pair of first connection parts 252. As shown in FIG. 9, the other coil lead-out wire 33c is pressed into the press-contact part 252c of each of the pair of first connection parts 252.

Moreover, in this embodiment, the coil 33 is composed of a coil wire covered with an insulating film, such as enamel, around a copper wire. In the case of using such a coil wire, as a method for electrically connecting the coil wire with the connection terminal, there are a method of connecting the coil wire with the connection terminal after removing at least the insulating film of the portion contacting with the connection terminal in advance, and a method of performing welding of joints such as fusing welding, which is able to join the copper wire to the connection terminal while melting the enameled wire.

On the other hand, in this embodiment, as described above, the corner 252g tapering toward the radially inner side and the corner 252h tapering toward the radially outer side are defined at each of the pressure contact parts 252c and 252d. The corners 252g and 252h face each other in the radial direction. The dimension of the interval between the corners 252g and 252h is smaller than the diameter of the coil lead-out wire 33c. Thus, when the coil lead-out wire 33c from which the insulating film has not been removed is inserted into the inner sides of the press-contact parts 252c and 252d from the upper side of the first connection part 252, the insulating film of the coil lead-out wire 33c is able to be torn via the corners 252g and 252h, and so each of the press-contact parts 252c and 252d is able to be brought into contact with the cooper wire of the coil lead-out wire 33c. Thereby, in the process of connecting the coil lead-out wire 33c to the connection terminal 250, there is no need for the work of removing the insulating film of the coil lead-out wire 33c, so it is possible to simplify the work of connecting the coil lead-out wire 33c to the connection terminal 250. Moreover, the coil lead-out wire 33c is able to be electrically connected to the connection terminal 250 only by a simple work of inserting the coil lead-out wire 33c into the inner side of the press-contact parts 252c and 252d, so it is possible to simplify the work of connecting the coil lead-out wire 33c to the connection terminal 250, as compared with the case of performing a work of welding of joints such as fusion welding. Therefore, it is possible to suppress an increase in manufacturing man-hours of the motor 2 and the pump 1.

According to this embodiment, the connection terminal 250 has the first connection part 252 connected to the terminal body 51. The press-contact parts 252c and 252d, which are recessed toward the lower side, namely the axial other side from the upper side of the first connection part 252, namely the end on axial one side, and open in the direction perpendicular to the axial direction, are provided in the first connection part 252. The coil lead-out wire 33c is passed through the inner side of the press-contact parts 252c and 252d, and pressed into the press-contact parts 252c and 252d. Thus, the coil lead-out wire 33c is able to be firmly fixed to the first connection part 252, and therefore it is possible to prevent the coil lead-out wire 33c from falling off from the connection terminal 250. Furthermore, since the contact area between the coil lead-out wire 33c and the connection terminal 250 is able to be enlarged, it is possible to reduce the contact resistance between the coil lead-out wire 33c and the connection terminal 250. Thereby, the coil 33 and the circuit board 70 are able to be stably connected via the connection terminal 250, so it is possible to drive a motor 202 and a pump 201 stably, and improve the output efficiency of the motor 2.

According to this embodiment, the connection terminal 250 has the pair of first connection parts 252 that are arranged facing each other in the direction perpendicular to the axial direction. The coil lead-out wire 33c is passed through the inner side of the press-contact parts 252c and 252d of each of the pair of first connection parts 252, and pressed into the press-contact parts 252c and 252d of each of the pair of first connection parts 252. Thus, two places of the coil lead-out wire 33c are firmly fixed to the first connection part 252, so it is possible to better suppress the coil lead-out wire 33c from falling off the connection terminal 250, and further reduce the contact resistance between the coil lead-out wire 33c and the connection terminal 250. Thus, it is possible to drive the motor 202 and the pump 201 more stably, and improve the output efficiency of the motor 202 more appropriately.

The configuration of the second connection part 53 is not limited to this embodiment, and for example, as shown by a dotted line in FIG. 8, the second connection part may protrude toward the upper side from the first connection part 252. In this configuration, it is preferable that each of the second via holes 70b shown in FIG. 5 be provided at a position that overlaps the second connection part 53 when viewed from the axial direction.

The disclosure is not limited to the above embodiments, and other configurations and other methods may be adopted within the scope of the technical idea of the disclosure. For example, the number of terminal holding parts of the second housing is not limited to three, but may be less than two or more than four. Moreover, the terminal holding part may be separated from the bus base, and in this case, the terminal holding part is able to be fixed to the inner peripheral surface of the bus base by a fixing method such as adhesion.

Moreover, the number of connection terminals of the motor is not limited to three, but may be less than two or more than four. Moreover, the number of coil lead-out wires connected to the connection terminals may be one or more than three.

Moreover, the number of flanges that the second housing has may be three or more. Moreover, the flange may be provided on the cover member or on the first housing.

Moreover, the method of connecting the second connection part 53 and the second via hole 70b is not limited to press-fitting, and they may be connected by other methods such as soldering.

The use of the motor to which the disclosure is applied is not particularly limited. The motor may also be installed in equipment other than the pump. The use of the pump equipped with the motor to which the disclosure is applied is not particularly limited. The type of fluid conveyed by the pump is not particularly limited, and it may be water, etc. The motor and the pump may also be installed in equipment other than vehicles. Moreover, each structure and each method described in this specification may be appropriately combined within a mutually consistent range.

Moreover, the present technology may adopt the following configuration. (1) A motor, including a motor part including a rotor rotatable around a central axis, and a stator facing the rotor in a radial direction with a gap therebetween; a circuit board arranged on an axial one side of the motor part; a connection terminal arranged between the stator and the circuit board in an axial direction; a first housing having a first opening that is open at the axial one side and accommodating the motor part; and a second housing arranged on the axial one side of the first housing. The stator includes: an annular stator core fixed to the first housing; a coil including multiple coil bodies attached to the stator core; and an insulator arranged between the stator core and the coil. The connection terminal electrically connects the coil and the circuit board. The second housing includes: a board accommodator having a cylindrical shape that extends in the axial direction and accommodating the circuit board; a board holding part holding the circuit board, and a terminal holding part holding the connection terminals. An outer peripheral surface of the board accommodator constitutes a portion of an outer peripheral surface of the second housing. The terminal holding part is connected to an inner side surface of the board accommodator. (2) The motor according to (1), in which the coil includes a coil lead-out wire lead out from the coil body to the axial one side and connected to the connection terminal, and the terminal holding part is arranged further on the axial one side than the stator core. (3) The motor according to (2), in which the terminal holding part includes a body protruding toward the radially inner side from the inner side surface of the board accommodator. The body has a holding hole penetrating the body in the axial direction, and a first recess in the body that is recessed toward an upper side from a lower side further on the radially inner side than the holding hole. The connection terminal includes a terminal body extending in the axial direction. A body bump protruding toward the radially inner side is provided in the terminal body. A portion of the terminal body on the axial other side is arranged inside the holding hole. The body protrusion is arranged in the first recess. (4) The motor according to (3), in which the coil includes a transition wire extending along an circumferential direction on the radially outer side of the insulator and connecting the coil body with the coil lead-out wire. When viewed from the axial direction, the holding hole overlaps the transition wire. (5) The motor according to (3) or (4), in which the terminal holding part has a protrusion protruding toward the radially inner side from the body. A second recess, which is recessed toward the axial one side and open at both sides in the circumferential direction, is provided on a surface of the protrusion facing the axial other side. The coil lead-out wire is passed through an inner side of the second recess in the circumferential direction and bends toward the axial one side at a circumferential end of the second recess. (6) The motor according to (5), in which a restriction is provided on a surface of the protrusion facing the circumferential direction, facing the coil lead-out wire in the circumferential direction. The coil lead-out wire extends in the axial one side along a surface of the restriction facing the radially inner side. (7) The motor according to any one of (3) to (6), in which the body has a third recess that is recessed toward the axial other side from a portion in a surface of the body facing the axial one side, overlapping the first recess when viewed from the axial direction. An inner side surface of the holding hole has an inclined surface located on the radially outer side as it moves from an edge of the radially outer side of the third recess toward the axial other side. (8) The motor of any one of (3) to (7), in which the connection terminal includes a first connection part connected to the terminal body. A press-contact part, which is recessed toward the axial other side from an end on the axial one side of the first connection part and open in a direction perpendicular to the axial direction, is provided in the first connection part. The coil lead-out wire is passed through an inner side of the press-contact part and pressed into the press-contact part. (9) The motor according to any one of (3) to (7), in which the connection terminal includes a second connection part protruding toward the axial one side from the terminal body. The second connection part is connected to the circuit board. (10) The motor according to any one of (3) to (7), in which the connection terminal includes a first connection part connected to the terminal body and a second connection part protruding toward the axial one side from the first connection part. A press-contact part, which is recessed toward the axial other side from an end on the axial one side of the first connection part and open in a direction perpendicular to the axial direction, is provided in the first connection part. The coil lead-out wire is passed through an inner side of the press-contact part and pressed into the press-contact part. The second connection part is connected to the circuit board. (11) The motor according to any one of (8) to (10), in which the connection terminal includes a pair of first connection parts arranged facing each other in the direction perpendicular to the axial direction. The coil lead-out wire is passed through the inner side of the press-contact part of each of the pair of first connection parts and pressed into the press-contact part of each of the pair of the first connection parts. (12) The motor according to any one of (1) to (11), in which the board accommodator has a second opening that is open at the axial other side. An inside of the first housing and an inside of the second housing are connected to each other via the first opening and the second opening. (13) The motor according to any one of (1) to (12), in which the motor is fixed to a mounted body. The second housing has a flange protruding toward the radially outer side from the board accommodator. The flange is fixed to the mounted body. (14) A pump, including a motor according to any one of (1) to (13) and a pump mechanism connected to the rotor.

### INDUSTRIAL APPLICABILITY

Features of the above-described preferred embodiments and the modifications thereof may be combined appropriately as long as no conflict arises. While preferred embodiments of the present disclosure have been described above, it is to be understood that variations and modifications will be apparent to those skilled in the art without part from the scope and spirit of the present disclosure. The scope of the present disclosure, therefore, is to be determined solely by the following claims.

What is claimed is:

1. A motor, comprising:
a motor part comprising a rotor rotatable around a central axis, and a stator facing the rotor in a radial direction with a gap therebetween;
a circuit board arranged on an axial one side of the motor part;
a connection terminal arranged between the stator and the circuit board in an axial direction;
a first housing having a first opening that is open at the axial one side and accommodating the motor part; and
a second housing arranged on the axial one side of the first housing,
wherein the stator comprises: an annular stator core fixed to the first housing, a coil comprising a plurality of coil bodies attached to the stator core, and an insulator arranged between the stator core and the coil,
the connection terminal electrically connects the coil and the circuit board,
the second housing comprises:
a board accommodator having a cylindrical shape that extends in the axial direction and accommodating the circuit board;
a board holding part holding the circuit board; and
a terminal holding part holding the connection terminal,
an outer peripheral surface of the board accommodator constitutes a portion of an outer peripheral surface of the second housing, and
the terminal holding part is connected to an inner side surface of the board accommodator.

2. The motor according to claim 1,
wherein the coil comprises a coil lead-out wire led out from the coil body to the axial one side and connected to the connection terminal, and
the terminal holding part is arranged further on the axial one side than the stator core.

3. The motor according to claim 2,
wherein the terminal holding part comprises a body protruding toward an radially inner side from the inner side surface of the board accommodator,
the body has a holding hole penetrating the body in the axial direction, and a first recess in the body that is recessed toward an upper side from a lower side further on the radially inner side than the holding hole,
the connection terminal comprises a terminal body extending in the axial direction,
a body bump penetrating toward the radially inner side is provided in the terminal body, and
a portion of the terminal body on an axial other side is arranged inside the holding hole, and the body bump is arranged in the first recess.

4. The motor according to claim 3,
wherein the coil comprises a transition wire extending along an circumferential direction on a radially outer side of the insulator and connecting the coil body and the coil lead-out wire, and
when viewed from the axial direction, the holding hole overlaps the transition wire.

5. The motor according to claim 3,
wherein the terminal holding part has a protrusion protruding toward the radially inner side from the body, and
a second recess, which is recessed toward the axial one side and open at both sides in the circumferential direction, is provided on a surface of the protrusion facing the axial other side,
the coil lead-out wire is passed through an inner side of the second recess in the circumferential direction and bends toward the axial one side at a circumferential end of the second recess.

6. The motor according to claim 5,
wherein a restriction is provided on a surface in a surface of the protrusion facing the circumferential direction, facing the coil lead-out wire in the circumferential direction, and
the coil lead-out wire extends in the axial one side along a surface of the restriction facing the radially inner side.

7. The motor according to claim 3,
wherein the body has a third recess that is recessed toward the axial other side from a portion in a surface of the body facing the axial one side, overlapping the first recess when viewed from the axial direction, and
an inner side surface of the holding hole has an inclined surface located on the radially outer side as it moves from an edge on the radially outer side of the third recess toward the axial other side.

8. The motor according to claim 3,
wherein the connection terminal comprises a first connection part connected to the terminal body,
a press-contact part, which is recessed toward the axial other side from an end on the axial one side of the first connection part and open in a direction perpendicular to the axial direction, is provided in the first connection part, and
the coil lead-out wire is passed through an inner side of the press-contact part and pressed into the press-contact part.

9. The motor according to claim 3,
wherein the connection terminal comprises a second connection part protruding toward the axial one side from the terminal body, and
the second connection part is connected to the circuit board.

10. The motor according to claim 3,
wherein the connection terminal comprises a first connection part connected to the terminal body and a second connection part protruding toward the axial one side from the first connection part,
a press-contact part, which is recessed toward the axial other side from an end on the axial one side of the first connection part and open in a direction perpendicular to the axial direction, is provided in the first connection part,
the coil lead-out wire is passed through an inner side of the press-contact part and pressed into the press-contact part, and
the second connection part is connected to the circuit board.

11. The motor according to claim 8,
wherein the connection terminal comprises a pair of first connection parts arranged facing each other in the direction perpendicular to the axial direction, and
the coil lead-out wire is passed through the inner side of the press-contact part of each of the pair of first connection parts and pressed into the press-contact part of each of the pair of the first connection parts.

12. The motor according to claim 1,
wherein the board accommodator has a second opening that is open at the axial other side, and
an inside of the first housing and an inside of the second housing are connected to each other via the first opening and the second opening.

13. The motor according to claim 1,
wherein the motor is fixed to an mounted body,
the second housing has a flange protruding toward the radially outer side from the board accommodator, and
the flange is fixed to the mounted body.

14. A pump, comprising:
a motor according to claim 1, and a pump mechanism connected to the rotor.
